(19) United States
(12) Patent Application Publication
(10) Pub. No.: US 2021/0295371 A1
(43) Pub. Date: Sep. 23, 2021

(54) ADVANCED SEARCH ENGINE FOR BUSINESS

(71) Applicant: Stephen Byrd, Bowie, MD (US)

(72) Inventor: Stephen Byrd, Bowie, MD (US)

(21) Appl. No.: 16/823,370

(22) Filed: Mar. 19, 2020

(51) Int. Cl. G06Q 30/02; G06F 16/953

(52) U.S. Cl. CPC G06Q 30/0239; G06F 16/953

(57) ABSTRACT

The present invention discloses system and method of a search engine for searching businesses and their business deals in the user's proximity. The query entered by the end user in search engine interface is processed by the search engine by merging all the data into a single consistent data structure file. The search engine standardizes the multiple formats encountered when deriving pages from various sources. A list of potential indexable elements is identified and extracted to an index list. The system is configured to filter and extract business details and business deals from the world wide web.

### FIELD OF INVENTION

The invention relates to a search engine and in particular, the invention relates to a meta search engine that displays live business deals or offers along with live user video reviews of the same.

### BACKGROUND OF THE RELATED ART

In general, search engines follow a method which starts with a user entering search query in the search bar. This search query progresses to the server of the search engine. The user's search query is compared to the keywords in the search engine database. Any website URLs (uniform resource locators, or address) that are associated with these keywords are then presented to the user as search results.

Few existing prior arts in the abovementioned context includes U.S. Patent Application no. US20140040004A1 to Hamo et al. discusses a shopping system employing a computer-implemented method to determine whether an offer is a deal. It comprise associating offers received for a product with the product in a database; associating a time for each of the offers noting when each particular offer was effective; receiving a current offer for the product; identifying the offers for the product in the database that are within a configured time period of the current offer; comparing the offers for the product in the database with the current offer for the product based on a set of parameters; identifying the current offer as a deal in response to a determination that the current offer satisfies all parameters compared to the offers for the product in the database.

Another US Patent Publication No 20130231989A1 to Abu Ayyash discusses a system and method allows users to post reviews as video clips, showing others what their experience was and if the product was useful or not. Such video reviews add credibility to the reviewer. Yet another US Patent Publication No U.S. Pat. No. 8,635,169B2 to Avedissian et al. discusses a system and method that obtains and publishes user generated video product reviews by generating a user account and receiving a user generated video review associated with the user account, where the user generated video review comprises audio and video data featuring a reviewed product. The user generated video review is stored to a database comprising a plurality of user generated video reviews.

While several search engines present the search results including the extraneous search matter not relevant to the user query, the present invention specifically relates to a novel meta search engine system with enhanced accuracy and speed, less storage and computational requirements, the said search engine filters out or excludes the extraneous data and aggregates specific results to display to the end users.

### SUMMARY OF THE INVENTION

Embodiments of the present invention discloses a search engine system that has a novel review system and in particular a novel video review system.

In an embodiment of the present invention, the computer implemented system recommends live business deals and offers to the end user.

In yet another embodiment of the present invention, the search engine is designed only to showcase live deals specifically offered by the businesses that appears in the search query of the user; hence excluding extraneous search data.

In yet another embodiment of the present invention, the search engine system highlights live business deals and filters out the expired business deals and recommend the said deals to the customers or the end users.

Embodiments of the present invention relates to a method and system that allows the search engine system to recommended live business deals.

In yet another embodiment of the present invention, the system may provide instant customization of business deals advertisements without actual need of a backend operator.

It is a further an object of the present invention to devise a novel meta search engine system with enhanced accuracy and speed, less storage and computational requirements, the said search engine requests several other search engines and databases for desired information, filters out or excludes the extraneous data and aggregates specific results to display to the end users.

It is yet another object of the present invention to devise a novel meta search engine system wherein the end users may post live video reviews on various businesses and their live business deals.

Additional features and advantages of the invention will be set forth in the description which follows, and in part will be obvious from the description, or may be learned by the practice of the invention. These and other features of the present invention will become fully apparent from the following description or may be learned by the practice of the invention as set forth hereinafter.

### BRIEF DESCRIPTION OF THE ACCOMPANYING DRAWINGS

FIG. 1 illustrates an exemplary network diagram embodying the present invention.

FIG. 2 illustrates an exemplary architecture diagram of the present invention.

FIG. 3 illustrates a block diagram of the system embodying the present invention.

FIG. 4 illustrates an exemplary screenshot of the search page of the present invention.

FIG. 5 illustrates an exemplary screenshot of the review system of the present invention.

FIG. 6 illustrates an exemplary screenshot of the analytics interfaces of the present invention.

FIG. 7 illustrates an exemplary screenshot of the module that displays search analytics of the present invention.

FIG. 8 illustrates an exemplary screenshot of the user interface that displays customer details.

FIG. 9 illustrates an exemplary screenshot of the user interface showing business listings.

FIG. 10 illustrates an exemplary screenshot of the rating system of the present invention.

FIG. 11 illustrates pay for customer system.

FIG. 12 illustrates screenshot of the user interface displaying various “search packages.

### DETAILED DESCRIPTION OF THE PREFERRED EMBODIMENTS

In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well, known functions or constructions may not be described in detail for brevity or clarity.

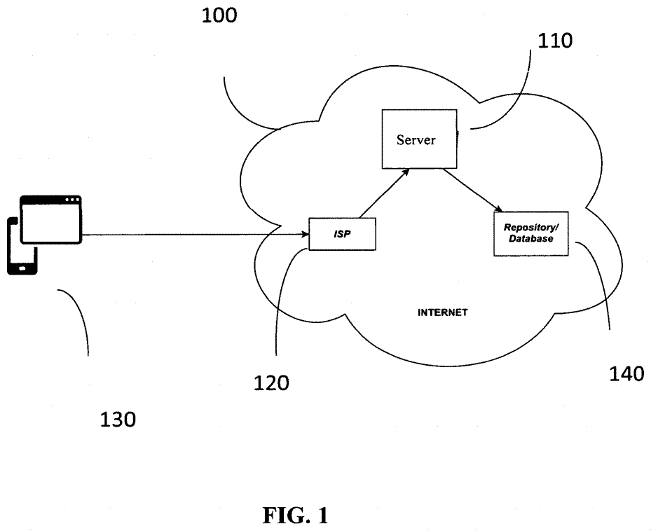

FIG. 1 illustrates a network diagram 100 according to an embodiment of the present invention. The search engine system includes user device 130, Internet service provider 120, web browser 140, Repository/database 150, server 110, internet 170. The user device 130 receives a search query from the user through the search engine's interface accessible from the web browser 140 of the user device. The search query is sent to the server 110 through internet service provider 120. The search engine of the present invention is configured to search data from the repository or data storage 150 and present the filtered search results on the user device 130.

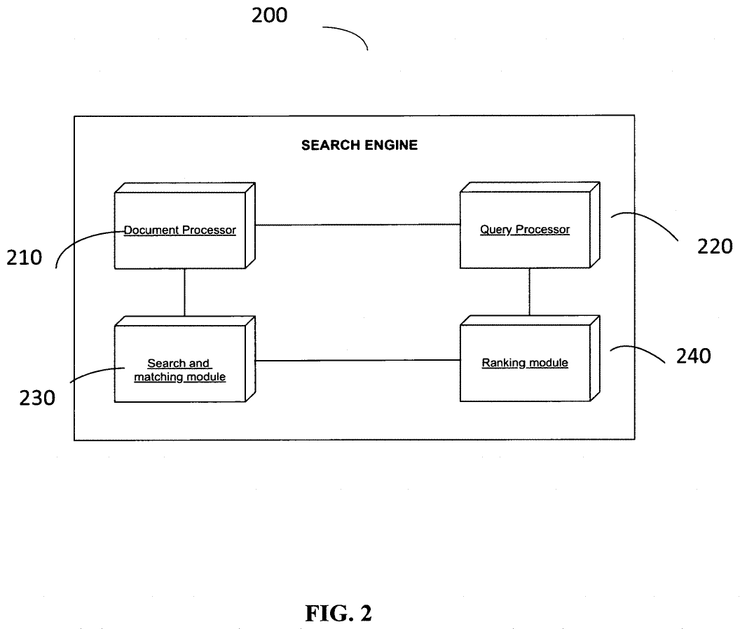

FIG. 2 illustrates an architecture of the search engine system 200 comprising document processor 210, query processor 220, search and matching module 230 and ranking module 240.

The document processor 210 pre-processes the searched data by merging all the data into a single consistent data structure. For this, the document processor standardizes the multiple formats encountered when handling various websites. The document processor identifies potential indexable elements or keywords from the search query entered by the user. The document processor extracts the indexed entries or keywords from various website on the world wide web.

The query processor 220 tokenize the query stream i.e. break it down into understandable segments as soon as the user inputs query on the system interface of the search engine. A person skilled in the art should note that the search engine can be a keyword based system or a natural language processing (NLP) system. The search engine creates a query representation and performs the search.

The search and matching function module 230 searches the queries entered by the user. The search and matching function module 230 determines which subset of webpages matches the keyword query of the user to some degree, a similarity score is computed between the query and each document or webpage by the system. After computing the similarity of each webpage in the subset of websites, the system presents an ordered list to the user. The search engine determines rank, the ranked result list goes to the user, who can then simply click and follow the system's internal pointers to the selected website or business deal. The features that make relevant match to the searched queries are: term frequency, location of terms, link analysis, popularity, date of publication, length, proximity of query terms, proper nouns. The ranking module 240 of the search engine determines rank and the ranked results list goes to the user who can then simply click and follow the system's internal pointers to the selected website on the world wide web.

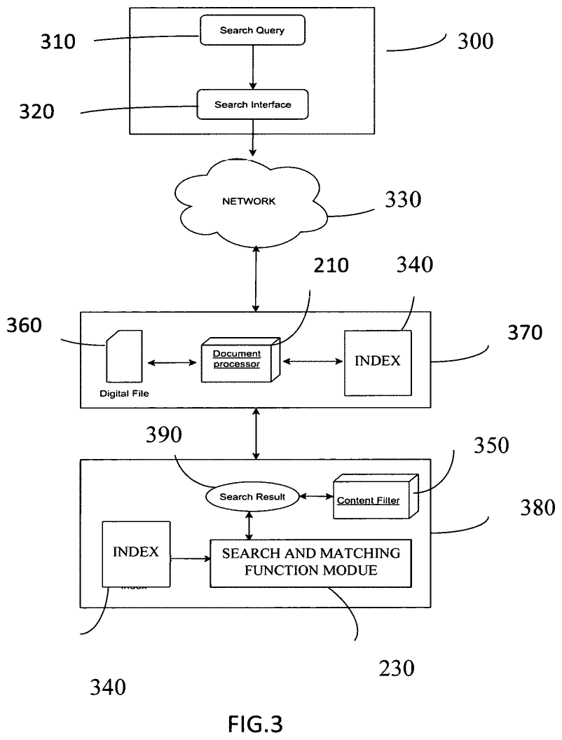

FIG. 3 illustrates an exemplary block diagram 300 of the present invention illustrating the working of the present search engine system. At step 310, the user enters query in the search engine interface 320 displayed on the user device. The query entered is sent to the search engine through network 330. At step 370, the document processor 210 preprocess the searched data by merging all the data into a single consistent data structure file 360. For this the document processor standardize the multiple formats encountered when deriving documents. A well formed consistent document is required for efficient preprocessing at later stages. The document processor identifies potential indexable elements. The document processor extracts the remaining index entries from the original document or webpage to the index list 340.

At step 380, the indexed list 340 is used to determine which subset of documents or webpages matches the query requirements. The search and matching function module 240 computes the similarity of each webpage in the subset of websites or webpages and generates an ordered list of search results 390 which is filtered by the content filter module 350 of the system to extract businesses and live deals data.

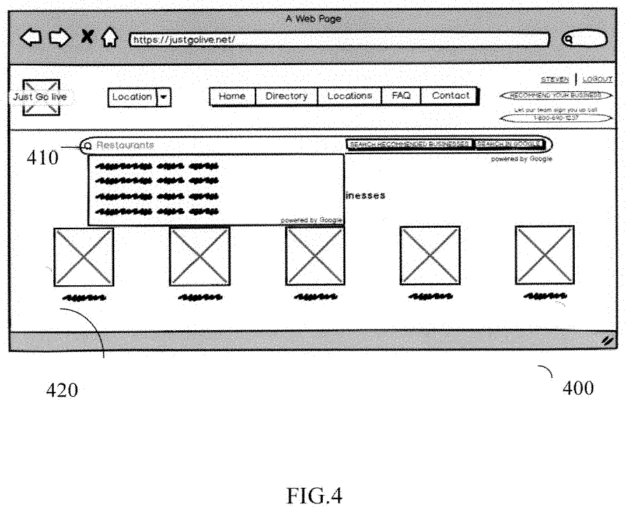

FIG. 4 is an exemplary screenshot of an embodiment 400 of the present invention comprising a search bar 410 wherein the user enters the search query, and simultaneously the system displays indexed search suggestions 420 as drop downs. The present system displays the search results of the businesses in the proximity of the user by capturing the GPS coordinates of the user device and thereby suggesting the business deals in the vicinity of the user.

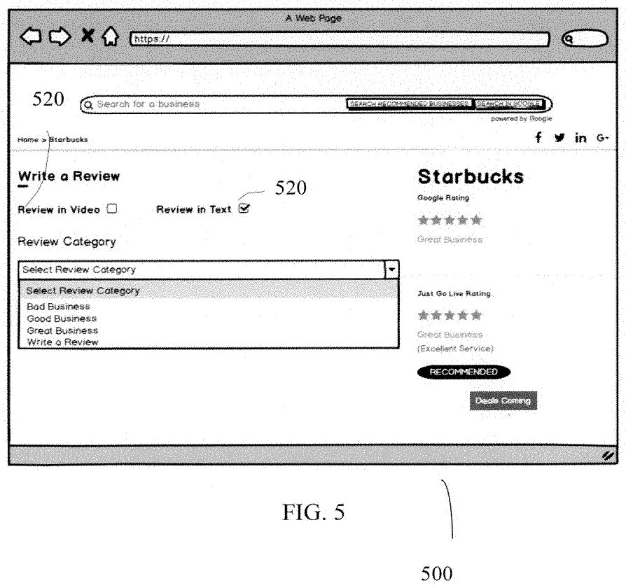

FIG. 5 is an exemplary screenshot of an embodiment 500 of the present invention comprising a review interface where a user can enter a video review 510 or a text review 520 based upon their preferences.

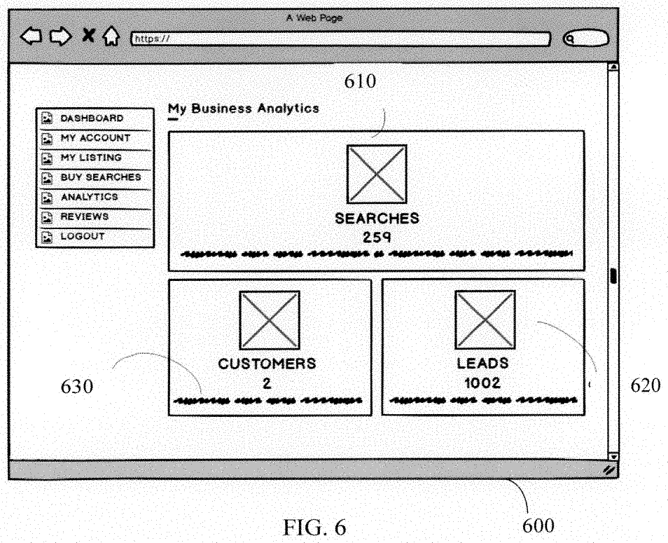

FIG. 6 is an exemplary screenshot of an analytics module 600 of the present invention comprising the information on how many times the business got searched 610 by the customers or users online, number of reviews left by the customers 630 and number of visitors 620 who visited a specific business deal or website.

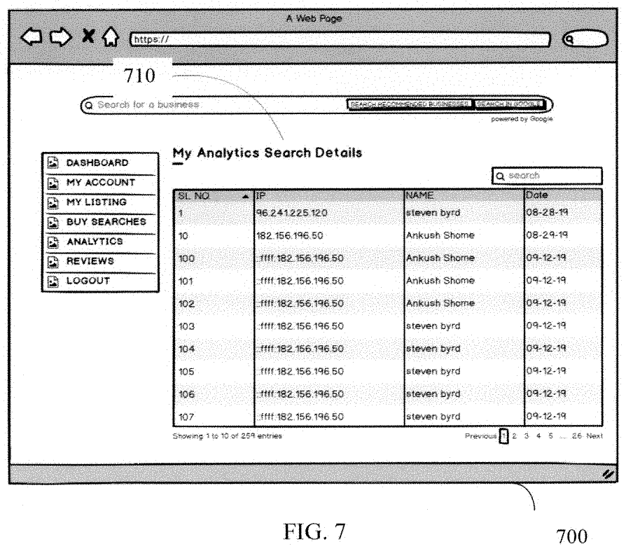

FIG. 7 illustrates yet another screenshot of an embodiment 700 of the present invention comprising analytics search results 710 displaying the list of users who visited a business deal or website along with their IP addresses and date of visiting a particular business deal or website.

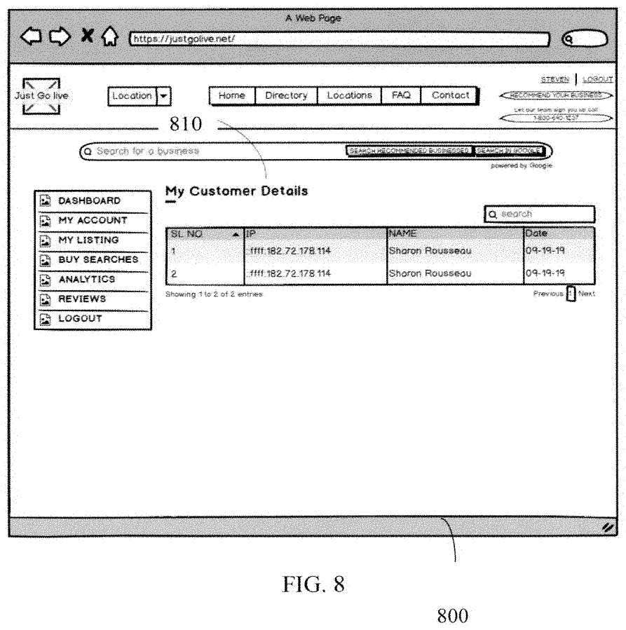

FIG. 8 illustrates yet another embodiment 800 of the present invention describing customer details 810 including names and IP addresses of the customers and dates on which they left a text or video review on a business deal.

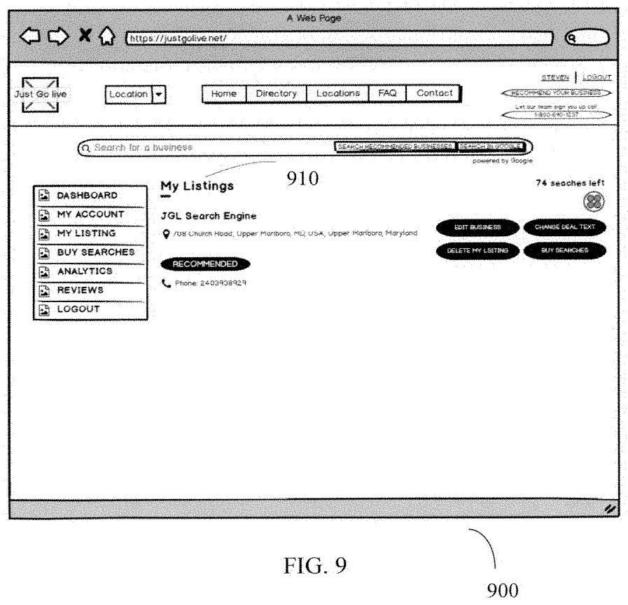

FIG. 9 illustrates yet another embodiment 900 of the present invention describing business listings 910 where the registered owners/representatives of the businesses may edit business information, change business deal information, delete the business listing and opt in to buy a certain business search package.

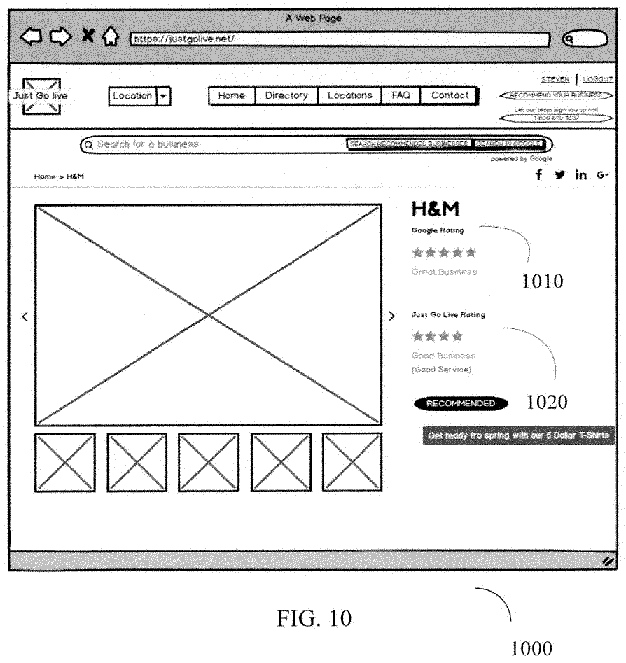

FIG. 10 illustrates yet another embodiment 1000 of the present invention describing ratings of a business web page 1020 of the present system as well as google rating 1010 of a particular business. The meta search engine can display both the Google® rating and present search engine's rating. The search engine of the present invention has different and novel rating system where the business can be rated and displayed as good business, average business and poor business.

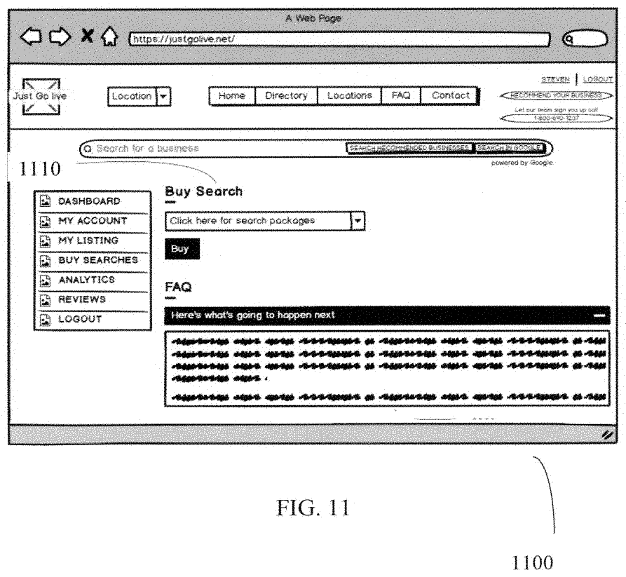

FIG. 11 illustrates yet another screenshot of the embodiment 1100 of the present invention describing pay for customer system where business owners can recommend their business by simply buying searches through pay per customer search system. The pay per customer search system allows business owners/representatives to showcase their business alongside the other businesses by showcasing instant deals. The business owner/representative can choose how many searches they want and set keywords in the system representing their deals. Therefore each time a user inputs a query comprising those keywords, the relevant business deal is displayed by the system. Each time the relevant business deal is displayed, the total number of searches in the package opted by the business deducts accordingly. Whenever a user search a keyword, the present system records the number of times a specific keyword has been searched by the user. The present system analytics also gathers information such as who searched the keyword, location of the user searching the keyword, date on which the keyword was searched. The present search engine is configurable such that it may be integrated with third party applications also.

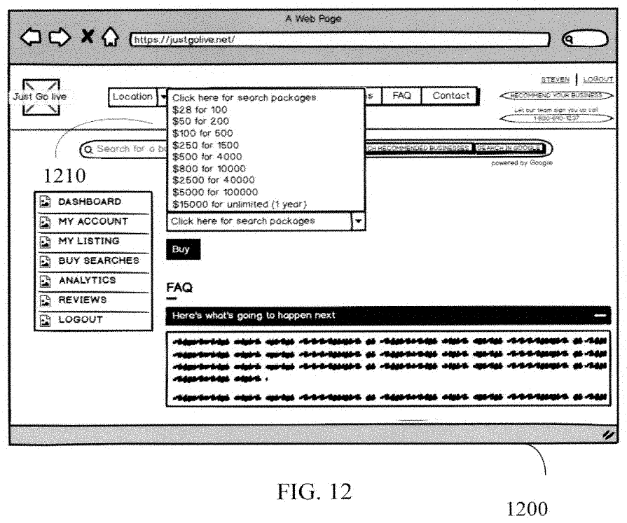

FIG. 12 illustrates screenshot of an embodiment 1200 of the present invention showing the screenshot of the user interface of the present system displaying various “search packages” 1210 offered to the businesses inclined to showcase their business deals to the customers using the present invention.

While a number of preferred embodiments have been described, it will be appreciated by a person skilled in the art that numerous variations and/or modifications may be made in the invention without departing from the spirit or scope of the invention as broadly described. The present embodiments are, therefore, to be considered in all respects as illustrative and not restrictive. The words “customer” and “user”, “webpage” and “websites” have been used interchangeably in the above discussed specification. Therefore, the present invention is not limited to the above embodiments that the person should be made under the inspiration of this novel utility of the present invention the same or similar technical solution has, fall within the scope of the present invention.

I/We claim:

1. A computer implemented method of reviewing business deals, comprising the steps of:
a) receiving a query from the user device;
b) processor of the server device executing received query;
c) processor of the server device crawling the world wide web for plurality of records including plurality of business websites and plurality of live business deals;
d) processor of the server device indexing and organizing plurality of records including plurality of business websites and plurality of business deals;
e) determining a set of keywords from the database storing plurality of keywords associated with specific ranking values;
f) generating plurality of results for the searched query;
g) displaying plurality of results for the searched query.

2. A search engine system executing the steps of:
a) searching the world wide web for plurality of business websites and plurality of live business deals;
b) searching the system database for plurality of business websites and plurality of live business deals;
c) crawling the world wide web for plurality of records including plurality of business websites and plurality of live business deals;
d) indexing and organizing plurality of records including plurality of business websites and plurality of business deals;
e) determining a set of keywords from the database storing plurality of keywords associated with specific ranking values;
f) generating plurality of results for the searched query;
g) displaying plurality of results for the searched query

3. A search engine system according to claim 2, wherein the said system comprises an analytics module that calculates the number of searches and interests shown by plurality of users on plurality of live business deals displayed by plurality of business websites.

4. A search engine system according to claim 3, wherein the analytics module calculates the number or reviews left by the users on plurality of business websites.

5. A search engine system according to claim 4, wherein the analytics module calculates the number of times a user called a specific business.

6. A computer implemented method of reviewing business deals, comprising the steps of:
a. receiving by a server, a video file;
b. displaying by the user terminal, a video file;
c. transmitting by a user terminal to the server, a video file.

7. A computer implemented method according to claim 6, comprising the steps of receiving at least one of a video file and a text file.

8. A computer implemented method according to claim 7, wherein the video file and a text file are business deals reviews by the user.

9. A computer implemented method of reviewing business deals according to claim 1, wherein the server fetches live location of the user's device with GPS coordinates and displays live business deals in proximity of the user.

10. A computer implemented method of reviewing business deals according to claim 1, wherein the user device may be a tablet, a phablet, a desktop or mobile device.

11. A computer implemented method of reviewing business deals according to claim 2, wherein the said system filters results based on the search query entered by the user that matches the business records in the world wide web.

12. A computer implemented method of reviewing business deals according to claim 2, wherein the said system filters results based on the search query entered by the user that matches the business records in the system database.
